(19) United States
(12) Patent Application Publication
(10) Pub. No.: US 2005/0082274 A1
(43) Pub. Date: Apr. 21, 2005

(54) Substrate heater and fabrication method for the same

(75) Inventors: Nobuyuki Kondou, Handa-shi (JP); Hideyoshi Tsuruta, Toukai-shi (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/945,269

(22) Filed: Sep. 20, 2004

(30) Foreign Application Priority Data
Sep. 30, 2003 (JP) P2003-340920

(51) Int. Cl. H05B 3/68

(52) U.S. Cl. 219/444.1; 219/544

(57) ABSTRACT

The substrate heater includes a plate-shaped ceramics base having a heating surface on a side of the ceramic base for placing a substrate thereon. The substrate heater includes a resistance-heating element embedded in the ceramics base. The substrate heater includes a tubular member joined to a central portion on another side of the ceramics substrate. The heating surface has a convex shape having a central portion and a peripheral portion. The heating surface in a convex shape lowers in height as the heating surface extends from a central portion to a peripheral portion thereof.

### CROSS-REFERENCE TO RELATED APPLICATIONS

This application is based upon and claims the benefit of priority from Japanese Patent Application No. 2003-340920 filed on Sep. 30, 2003; the entire contents of which are incorporated herein by reference.

### BACKGROUND OF THE INVENTION

The present invention relates to a substrate heater for heating a semiconductor wafer, a liquid crystal substrate, and the like, which is used in a semiconductor fabricating process. More specifically, the present invention relates to a substrate heater where a resistance-heating element is embedded in a ceramics base.

Semiconductor equipment employs a substrate heater. The substrate heater employs a ceramics heater where a linear resistance-heating element is embedded in a discoid ceramics base. The substrate heater also extensively employs a ceramics heater with an electrostatic chuck function, where an electrostatic chuck electrode for fixing a substrate by adsorption is embedded with a resistance-heating element.

This ceramics heater includes a base formed of highly corrosion resistant ceramics, and the resistance-heating element is not exposed to outside. For this reason, the ceramics heater is suitable for use in a chemical vapor deposition (CVD) apparatus, a dry etching apparatus, and the like, which frequently apply corrosive gas.

The ceramics heater employed in the semiconductor equipment is applicable to a wide temperature range in dependence on the application, specifically in a range from room temperature to high temperature equal to or above 500° C. Meanwhile, for improvement in product yields, it is important to ensure temperature uniformity on the substrate. For this reason, the substrate heater is required to have temperature uniformity at a high temperature on a substrate-placing surface, that is, a substrate-heating surface.

For example, to improve temperature uniformity on a heating surface of a ceramics heater, conventionally, a method of achieving temperature uniformity on a heating surface has been disclosed (see Japanese Patent Publication No. 2527836, FIG. 1 and FIG. 3, etc.). According to this method, the spiral resistance-heating element embedded in the ceramics base is adjusted in spiral pitch and shape in dependence on the location.

In the substrate heater used in a CVD apparatus or a dry etching apparatus, the resistance-heating element has a terminal drawn outside without being exposed to the corrosive gas. For this reason, the following structure is frequently adopted, where the lower central portion of the ceramics base is joined to a shaft as a tubular member, and the shaft houses the terminal of the resistance-heating element, a feed bar to be connected thereto, and the like therein.

### SUMMARY OF THE INVENTION

In case of the ceramics heater provided with the shaft, heat tends to escape through the shaft joined to the ceramics base by way of heat transfer. Such a phenomenon tends to lower the temperature at the central portion of the heating surface in comparison with the peripheral portion thereof. In particular, a highly heat conductive material used as the shaft is highly likely to have such a tendency.

Meanwhile, the heating surface of the conventional ceramics heater is required to be as flat as possible in order to increase close contact with the substrate. Such flatness has been ensured by a lapping operation and the like. The substrate, mounted on the heating surface having fine flatness, tends to exhibit temperature distribution which directly reflects temperature distribution on the heating surface of the ceramics heater. Accordingly, the use of the ceramics heater with the shaft causes the central portion of the substrate surface to have a tendency to exhibit a temperature distribution which is lower than that of the outer peripheral portion thereof.

For improvement in temperature uniformity on the heating surface of the substrate heater, the method employs adjustment of the spiral resistance-heating element in spiral pitch and shape. In the meantime, the presence or absence of the shaft or the shape of the shaft requires optimization of the resistance-heating element in shape. The optimization renders design of the resistance-heating element troublesome and the process of the resistance-heating element complicated. After formation of the ceramics base with the resistance-heating element embedded therein, the resistance-heating element is incapable of adjustment in position and the like. Accordingly, it is difficult to perform a delicate correction operation.

The present invention is directed to a substrate heater and a fabrication method for the same. The substrate heater includes a tubular member (a shaft) joined thereto and is capable of achieving uniformity of temperature distribution on a substrate by use of a simple method.

The first aspect of the present invention provides the following substrate heater. The substrate heater includes a plate-shaped ceramics base having a heating surface on a side of the ceramic base for placing a substrate thereon. The substrate heater includes a resistance-heating element embedded in the ceramics base. The substrate heater includes a tubular member joined to a central portion on another side of the ceramics substrate. The heating surface in a convex shape lowers in height as the heating surface extends from a central portion to a peripheral portion thereof.

The entirely convex heating surface, with the substrate placed thereon, improves in closest contact with the substrate and the central portion of the heating surface. This enhances efficiency of heat transfer at the central portion, while relatively lowers efficiency of heat transfer at the peripheral portion. Thus, although the heating surface itself has a central portion lower in temperature than the peripheral portion due to influence of heat transfer, the surface of the substrate, placed on the heating surface, obtains substrate surface temperature with more uniform temperature distribution.

The ceramics base may include a planar electrode embedded therein between the heating surface and the resistance-heating element. The planar electrode may include a mesh-shaped electrode of a metal bulk body or a plate-shaped electrode with open holes.

The heating surface may have a vacuum chuck hole configured to adsorb and fix the substrate on the heating surface.

The adsorption force of an electrostatic chuck further secures close contact force between the substrate and the heating surface at the central portion of the heating surface. This enhances a substantial contact area, achieving higher effect in heat transfer. The adsorption force of the electrostatic chuck stably retains the substrate, thus reliably achieving shape-effect of the heating surface.

The heating surface has a height Hc at the central portion and a height He at an end of the heating surface. The heights Hc, He may have a difference ΔH of 50 μm or less therebetween.

The difference ΔH of 50 μm or less maintains an electrostatic chuck or a vacuum chuck at the peripheral portion of the substrate, thus stably keeping treatment in the substrate.

The second aspect of the invention provides the following fabrication method for a substrate heater. The method includes the step of embedding a resistance-heating element in a plate-shaped ceramics base. The method includes the step of grinding a surface of the ceramics base into a convex heating surface, the heating surface lowering in height as the heating surface extends from a central portion to a peripheral portion thereof The method includes the step of joining a tubular member to a central portion on another surface of the ceramics substrate.

The simple operation of grinding the entire heating surface into a convex shape improves in closest contact between the substrate and the central portion of the substrate, thus enhancing efficiency in heat transfer. Though the heating surface itself has a central portion lower in temperature than the peripheral portion due to influence of heat transfer, the surface of the substrate, placed on the heating surface, obtains uniform temperature distribution.

The step of embedding may include the step of embedding a planar electrode in the ceramics base.

The addition of an electrostatic chuck function to the substrate heater further secures close contact force between the substrate and the central portion of the heating surface. This improves substantial contact area, thus achieving higher effect in heat transfer. The adsorption force of electrostatic chuck function stably retains the substrate, clarifying shape effect of the heating surface.

The step of grinding may include the step of adjusting difference ΔH of 50 μm or less between height Hc of the central portion and height He of an end on the heating surface.

The difference ΔH of 50 μm or less maintains an electrostatic chuck or a vacuum chuck at the peripheral portion of the substrate, thus stably keeping treatment of the substrate.

The substrate heater and the fabrication method have a heating surface formed into a convexity by a simple grinding operation. This allows the heating surface to be uniformed in temperature distribution relative to the heating surface in a substrate heater with a tubular member.

### BRIEF DESCRIPTION OF THE ACCOMPANYING DRAWINGS

FIGS. 1A and 1B are cross-sectional views illustrating a structure of a substrate heater according to an embodiment of the present invention;

FIGS. 2A and 2B are cross-sectional views illustrating structures of a substrate heater with an electrostatic chuck and of a substrate heater with a vacuum chuck according to another embodiments of the present invention;

FIG. 3 is a flowchart diagram illustrating a fabrication method for the substrate heater illustrated in FIG. 1A;

FIGS. 4A and 4B are plan views illustrating shapes of resistance-heating elements to be embedded in the substrate heater illustrated in FIG. 1A; and

FIG. 5A is a plan view and FIG. 5B is a cross-sectional view respectively illustrating a structure of the substrate heater having a heating surface subjected to an embossing operation according to the embodiment of the present invention.

### DETAILED DESCRIPTION OF THE PREFERRED EMBODIMENTS

The following describes a substrate heater and a fabrication method thereof according to an embodiment of the present invention with reference to the accompanying drawings.

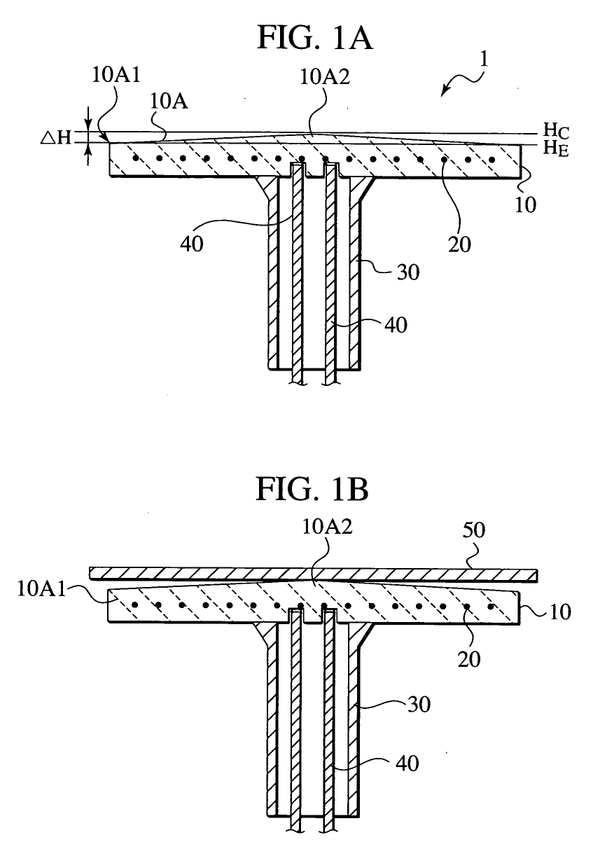

Referring to FIG. 1A, a structure of a substrate heater according to the embodiment of the present invention is described. A substrate heater 1 includes a ceramics base 10. The ceramics base 10 is made of an approximately discoid ceramics sintered body, for example, and includes a linear resistance-heating element 20 which is embedded inside the ceramics sintered body. The discoid ceramics base 10 includes a heating surface 10A on a side thereof The heating surface 10A includes a semiconductor substrate or a glass substrate as an object to be heated which is mounted thereon. The ceramics base 10 is joined to a shaft 30, or a tubular member, at the central portion on the opposite side. The shaft 30 houses a feed bar 40 as a feeder for supplying electricity to the resistance-heating element 20, in the tube thereof The end of this feed bar 40 is connected to a terminal of the resistance-heating element 20 by brazing solder or the like. In this way, joining of the shaft 30 to the central portion on the opposite side of the ceramics base 10 allows for heat-transfer to the shaft 30. The heat-transfer provides a tendency for the heating surface 10A to have a temperature lower at the central portion than at the outer peripheral portion.

The substrate heater 1, however, has a main characteristic in that the heating surface 10A has a so-called convex shape, where the central portion 10A2 is set to be highest and the heating surface is gradually lowered as the heating surface extends toward the peripheral portion 10A1. Accordingly, as shown in FIG. 1B, when a substrate 50 is mounted on the heating surface 10A, the substrate 50 contacts the heating surface 10A closely at the central portion 10A2 of the heating surface 10A due to the own weight. Such a contact provides fine heat-transfer efficiency and thereby raises the substrate temperature efficiently. On the contrary, the substrate 50 retains slight clearance between the heating surface 10A and the substrate 50 at the outer peripheral portion. The clearance reduces heat transfer efficiency at the outer peripheral portion 10A1 more than at the central portion 10A2. That is, if the heating surface 10A is a flat surface as in the conventional case, the temperature distribution on the surface of the substrate 50 will directly reflect the temperature distribution on the heating surface 10A of the ceramics base 10. On the contrary, the substrate heater 1 of the embodiment has the heating surface 10A in a convex shape. This shape increases the heat transfer efficiency to the substrate at the central portion 10A2 with a low temperature, and relatively reduces the heat transfer efficiency to the substrate at the outer peripheral portion 10A1 with a high temperature. In this way, it is possible to correct the temperature distribution on the substrate surface to be more uniform.

Here, the heating surface 10A has a height Hc at the central portion 10A2, and the height He at the edge portion 10A1. The difference ΔH (=Hc−He) in the height is preferably set to be equal to or below 30 μm. The difference above 30 μm renders the substrate 50 unstable, with the substrate placed on the heating surface 10A.

The difference ΔH is preferably set to be equal to or above 10 μm, or more preferably set to be equal to or above 20 μm. This ensures temperature uniformity on the substrate surface, thus rendering the difference in the heat conductivity between the central portion 10A2 and the outer peripheral portion 10A1 of the heating surface more effective.

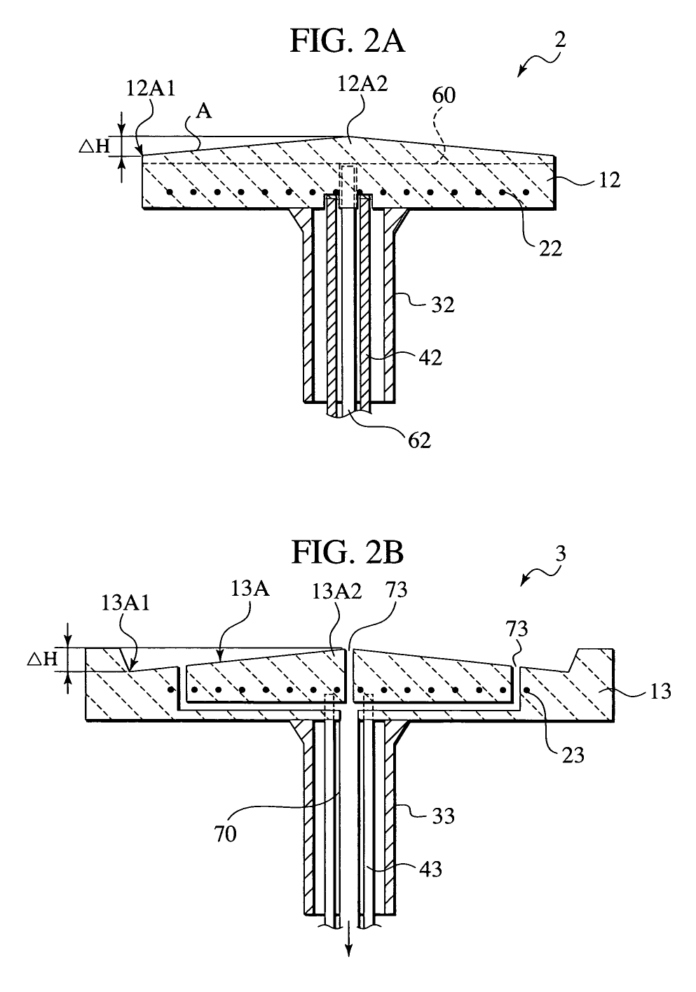

Referring to FIGS. 2A and 2B, the following describes examples of the structures of substrate heaters 2 and 3 provided with substrate adsorption functions according to another embodiments of the present invention. The substrate heaters 2 and 3 with the adsorption functions retains the substrate more stably than the substrate heater 1 shown in FIG. 1A.

The substrate heater 2 shown in FIG. 2A includes a resistance-heating element 22 and an electrostatic chuck electrode 60 which are embedded in a ceramics base 12 made of an approximately discoid ceramics sintered body. The ceramics base 12 includes a shaft 32 which is connected to the rear surface thereof. The shaft 32 houses therein a feed bar 42 for supplying electricity to a terminal of the resistance-heating element 22, and a feed bar 62 as a feeder to the electrostatic chuck electrode 60. In this way, the ceramics base 12 is joined to the shaft 32 at the central portion on the rear surface. Such a joint allows a tendency that heat transfer from the shaft 32 lowers the temperature at the central portion 12A2 of a heating surface 12A.

In the meantime, the substrate heater 2 with the electrostatic chuck includes a heating surface 12A. The heating surface 12A has a so-called convex shape in which, as in the case of the substrate heater shown in FIG. 1A, a central portion 12A2 is set to be highest and the heating surface is gradually lowered as the heating surface extends toward a peripheral portion 12A1. As compared to a substrate mounted on a flat heating surface 12A, a substrate mounted on the heating surface 12A in the convex shape tends to be unstable without any fixing means. The substrate of the substrate heater 2 shown in FIG. 2A is tightly adsorbed and fixed to the heating surface 12A due to the electrostatic chuck function. The heating surface 12A has the convex shape in which the central portion 12A2 is set to be highest. This shape allows the substrate to closely contact the central portion 12A2 of the heating surface 12A due to adsorption by the electrostatic chuck. This results in substantial expanded contact area, which achieves high heat-transfer efficiency. This heat-transfer efficiency raises the substrate temperature efficiently. On the contrary, the outer peripheral portion of the heating surface 12A retains slight clearance between the heating surface 12A and the substrate, and this clearance reduces the heat-transfer efficiency. This result improves temperature uniformity on the substrate surface mounted on the heating surface 12A.

When the Johnson-Rahbek principle is applied to the adsorbability of the electrostatic chuck, a distance between the heating surface 12A and the substrate to be mounted on the heating surface 12A influences the adsorbability. For this reason, the central portion 12A2 of the heating surface has a height Hc, and the edge portion 12A1 of the heating surface has a height He. The difference ΔH (=Hc−He) in the height exceeding 50 μm hinders sufficient adsorbability, which brings the substrate into a floating state. Therefore, the difference ΔH set to be equal to or below 50 μm is preferred for ensuring stable retention of the substrate.

The difference ΔH preferably set to be equal to or above 10 μm, or more preferably set to be equal to or above 20 μm ensures the temperature uniformity on the substrate surface, and clarifies the difference in the heat conductivity between the central portion 12A2 and the outer peripheral portion 12A1 of the heating surface 12A.

The substrate heater 3 shown in FIG. 2B includes a vacuum chuck function. The substrate heater 3 is different from the substrate heater 2 in that the vacuum chuck function is used as the adsorption function. Other parts of the fundamental structure are similar to those in the substrate heater provided with the electrostatic chuck shown in FIG. 2A.

As shown in FIG. 2B, a ceramics base 13 includes a resistance-heating element 23 embedded therein and vacuum chuck adsorption holes 73 arranged at multiple positions. These adsorption holes 73 are connected to an exhaust pipe 70. A substrate to be mounted on a heating surface 13A is fixed to the substrate heating surface 13A by adsorption through the respective adsorption holes 73. The adsorption holes 73 are not particularly limited in the number and locations.

As shown in FIG. 2B, the ceramics base 13 of the substrate heater 3 may include the heating surface 13A for mounting the substrate at the central portion, and the heating surface 13A may be surrounded by a frame part having a certain height. Such a frame part facilitates maintenance of a vacuum state.

The rear surface of the ceramics base 13 is connected to a shaft 33. The shaft 33 houses the exhaust pipe 70 therein, in addition to a feed bar 43 for supplying electricity to a terminal of the resistance-heating element 23. Heat transfer from the shaft 33 tends to lower the temperature at the central portion of the heating surface 13A.

In this substrate heater 3, the heating surface 13A also has a convex structure. Specifically, the central portion 13A2 is set to be highest and the heating surface is gradually lowered as the heating surface extends toward the outer peripheral portion 13A1. The heating surface 13A closely contacts the substrate at the central portion 13A2 thereof due to the adsorbability by the vacuum chuck. Such a contact provides fine heat transfer efficiency as a result of substantial expansion of the contact area, as well as raises the substrate temperature efficiently. At the same time, the heat transfer efficiency is slightly reduced at the outer peripheral portion 13A1 of the substrate due to clearance provided between the heating surface 13A and the substrate.

To maintain the adsorbability of the substrate by the vacuum chuck, the heating surface 13A has highest position of the central portion 13A2 with a height Hc and the lowest position of the edge portion 13A1 with a height He, for example. The adsorption hole 73A and the substrate have a distance exceeding 50 μm or less therebetween increases a leakage, thus bringing the substrate into a floating state. This does not maintain adsorbability to the heating surface 13A to be stable. Accordingly, a difference ΔH (=Hc−He) in the height set to be equal to or below 50 μm is preferred for ensuring stable retention of the substrate.

The difference ΔH is preferably set to be equal to or above 10 μm, or more preferably set to be equal to or above 20 μm. The difference ΔH renders the difference in the heat conductivity between the central portion and the outer peripheral portion of the heating surface more effective, thus ensuring temperature uniformity on the substrate surface.

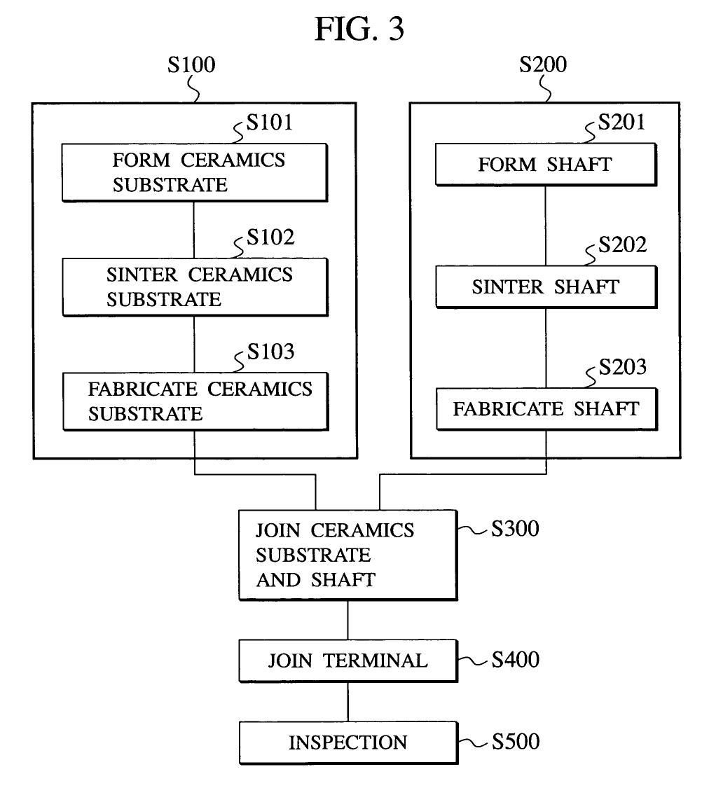

Next, a fabrication method of the substrate heater according to the embodiment of the present invention will be described with reference to a flowchart of FIG. 3. Here, a fabrication method of the substrate heater 2 provided with the electrostatic chuck shown in FIG. 2A will be described as a typical example. The ceramics base, the resistance-heating element, and the shaft may apply similar materials respectively in other substrate heaters.

As shown in FIG. 3, for fabrication of the substrate heater 2, firstly the ceramics base is fabricated, with the resistance-heating element and the electrostatic chuck electrode embedded therein (S100). At the same time, the shaft made of the ceramics sintered body is fabricated (S200). The ceramics base and the shaft are joined together (S300). The necessary terminal is joined to the shaft (S400) and the substrate heater is completed after an inspection operation (S500).

The following specifically describes the respective steps.

Firstly, in the ceramics base fabricating step (S100), the ceramics base is formed and then the ceramics base compact with the resistance-heating element and the electrostatic chuck embedded therein is fabricated (S101). This compact is sintered into the sintered body (S102), and then this sintered body is machined (S103). In the grinding step of the sintered body, the heating surface of the ceramics base is machined into the convex shape having the highest central portion.

Specifically, in the ceramics base forming step (S101), ceramics raw material-powder and sintering aids are put into a mold and pressed together, thereby fabricating a preliminary compact. The resistance-heating element is mounted on the preliminary compact, and the ceramics raw material powder is put thereon, and these constituents are pressed together again. When mounting the resistance-heating element, it is possible to form grooves in advance in locations on the preliminary compact for mounting the resistance-heating element. Then, the electrostatic chuck electrode made of a metal bulk body in the form of a mesh, for example, is mounted thereon. After putting the ceramics raw material powder thereon successively, all the constituents are pressed together again in a uniaxial direction. This forms the compact of the ceramics base with the resistance-heating element and the electrostatic chuck electrode embedded therein. The ceramics raw material powder may be formed by using AMN, SiC, SiNx, sialon or the like as a main ingredient with addition of a rare earth oxide such as Y₂O₃ as the sintering aids.

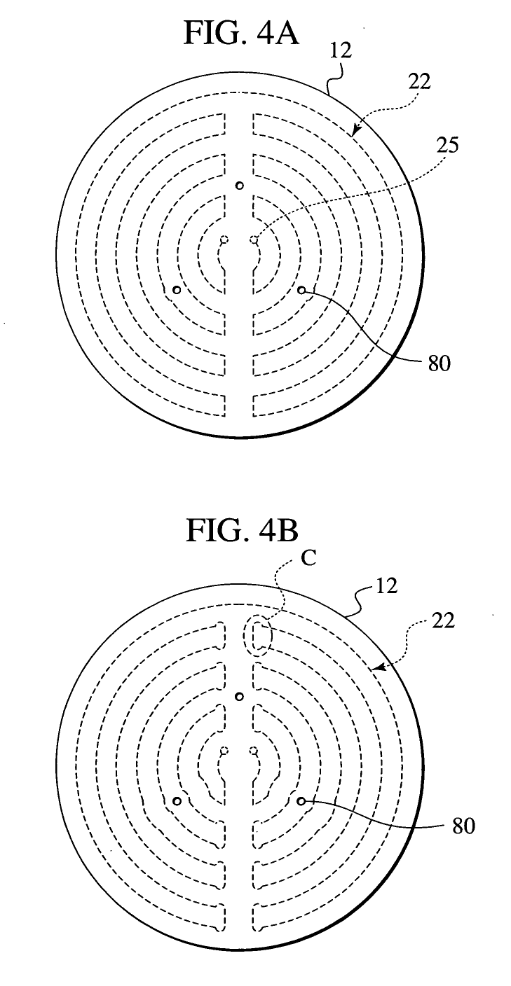

Examples of the resistance-heating element having a planar shape to be embedded in the ceramics base will be described with reference to FIG. 4A and FIG. 4B. The resistance-heating element 22 applies a single linear body, which is the metal bulk body made of high-melting point material such as Mo, W, or WC. As shown in FIG. 4A, this linear body includes two terminals 25 for the resistance-heating element which are positioned in the center. The linear body is folded back into a coil body. This coil shape may be modified into various shapes. As shown in FIG. 4A, it is possible to apply local modification around lift pins 80 so as to circumvent the lift pins 80 at a certain distance. Alternatively, as shown in FIG. 4B, folded portions C of the resistance-heating element 22 are provided with slight bulges. This narrows the distance between the adjacent resistance-heating elements, thus improving higher temperature uniformity of the heating surface 12A.

The electrostatic chuck preferably applies an electrode made of refractory metal such as Mo, W, or WC, which is capable of enduring sintering temperature, as in the case of the resistance-heating. For the electrostatic chuck, it is also possible to use an electrode made of a metal bulk body in the form of a mesh or an electrode having a punching metal shape provided with numerous holes on a plate body. Such a metal bulk body can lower the resistance of the electrode, and therefore may be used as a radio-frequency electrode. As to the metal bulk body, a hot press method may be used in the sintering step.

The resistance-heating element or the electrostatic chuck may employ a printed electrode. In this case, it is difficult to embed the electrode in the ceramics powder in the forming step. Accordingly, the printed electrode is formed on a green sheet instead. It is also possible to fabricate the compact of the ceramics base by laminating other green sheets on the printed electrode.

In the ceramics base sintering step (S102), the compact obtained in the forming step is sintered by use of the hot press method, for example. When aluminum nitride powder is used as the ceramics raw material powder, conditions for sintering are set to a nitrogen atmosphere, temperature in a range from 1700° C. to 2000° C., and a time period from about 1 hour to 10 hours. The pressure for the hot-press is preferably set to be from 20 kg/cm² to 1000 kg/cm² or above, or more preferably set to be from 100 kg/cm² to 400 kg/cm². The hot-press method applies the pressure in the uniaxial direction during sintering, thus achieving fine close contact of the resistance-heating element and the electrostatic chuck electrode to the surrounding ceramics base. The metal bulk electrode is not deformed by the pressure applied during the hot-press sintering.

In the ceramics base processing step (S103), the ceramics base after sintering is subjected to a drilling operation for providing holes for drawing out electrode terminals and a chamfering operation for corners. Concurrently, the heating surface 12A which is the surface of the ceramics base is machined into a certain convex shape. The grinding of the surface of the ceramics base is performed with a flat-surface grinding machine. The heating surface 12A is formed into the shape having the height Hc at the central portion 12A2 and the height He at the edge portion 12A1 of the heating surface 12A. The difference ΔH therebetween is set to be in a range from 10 μm to 50 μm, or more preferably in a range from 20 μm to 40 μm.

This ceramics base processing step does not always have to be performed upon completion of the sintering step. Instead, it is possible to perform the processing step by using a half-completed sintered body obtained by sintering at a temperature which is slightly lower than a finally required sintering temperature or by sintering for a shorter period. By processing the half-completed sintered body before completion of full sintering, the processing becomes easier to perform. When processing the half-completed sintered body, the half-completed sintered body is subjected to sintering again after the process.

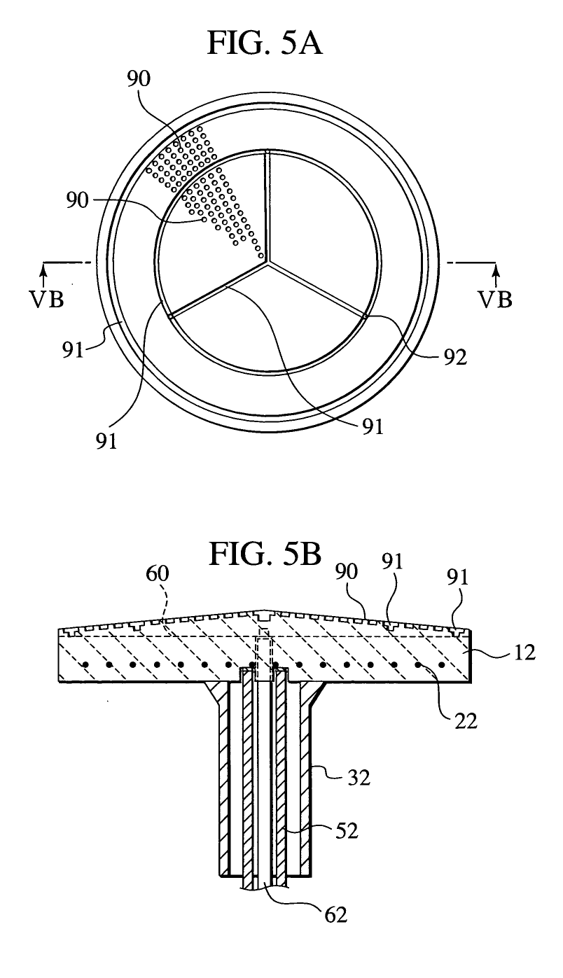

In the ceramics base processing step (S103), as shown in FIG. 5A and FIG. 5B, it is also possible to form embossments 90 on the surface of the ceramics base by use of a sandblasting method or the like. It is also possible to form purge gas holes 92, purge gas grooves 91, or holes for lift pins.

In the shaft fabricating step (S200), a compact of the shaft is firstly formed by use of ceramics raw material powder (S201). This compact is sintered into a sintered body (S202), and then this sintered body is processed (S203).

In the shaft forming step (S201), it is preferable to use the ceramics raw material powder of the same quality as that used in the ceramics base. In this way, it is possible to obtain a fine joint property to the ceramics base. Although various methods can be applied to the forming method, it is preferable to apply a cold isostatic pressing (CIP) method, a slip casting method, and the like, which are suitable for forming a relatively complicated shape.

In the shaft sintering process (S202), the compact obtained in the forming step is sintered. The compact having the complicated shape is preferably sintered by use of a normal pressure sintering method. When AIN is used as the ceramics raw material, conditions for sintering are set to a nitrogen atmosphere, temperature in a range from 1700° C. to 2000° C., and a time period from about 1 hour to 10 hours.

In the shaft processing step (S203), surfaces of the sintered body and joint surfaces are subjected to a lapping, and the like.

Next, the ceramics base and the shaft obtained by the methods are joined together (S300). In this joint step (S300), a rare earth compound is applied to one or both of joint surfaces as a joint agent. Thereafter, the joint surfaces are attached to each other and are then subjected to a heat treatment in a nitrogen atmosphere and in a temperature in a range from 1700° C. to 1900° C. It is also possible to apply a certain pressure uniaxially from a direction perpendicular to the joint surfaces where appropriate. In this way, the ceramics base and the shaft are joined together by solid-state welding. Instead of the solid-state welding, it is also possible to perform brazing solder or mechanical joining.

Moreover, the feed bar made of Ni or the like is inserted into the shaft. The electrode terminal of the ceramics base is joined to the feed bar inserted into the shaft by brazing solder, allowing for joining of the terminal (S400). Instead of the feed bar, it is also possible to use other feeder such as a linear conductive material formed into a rope or a conductive material formed into a ribbon. Additionally, by providing of screw grooves on an outer periphery of the feed bar while providing screw grooves on the ceramics base, and screwing of the feed bar into the ceramics base, it is also possible to achieve the joining to the electrode terminal.

Thereafter, an inspection (S500) is performed in terms of the temperature uniformity, adsorption uniformity, and the like, thus completing the substrate heater 2 provided with the electrostatic chuck.

The ceramics base and the shaft are not particularly limited in size and shape. Meanwhile, when a diameter of the heating surface of the ceramics base is expressed by D1 and a diameter of the cross-section of the shaft is expressed by D2, it is preferable to set D2/D1 to be in a range from ½ to 1/10, for example. In this case, it is possible to obtain the effect of forming the heating surface into the convex shape more surely.

With regard to the process of the heating surface of the ceramics base, it is also possible to perform a correction operation after the inspection step (S500) while reflecting a result of the inspection.

When fabricating the substrate heater 1 without the adsorption function as shown in FIG. 1A, it is possible to omit the step of embedding the electrostatic chuck out of the steps. When fabricating the substrate heater 3 provided with the vacuum chuck as shown in FIG. 2B, in order to fabricate exhaust holes for the vacuum chuck, the ceramics base is separated into plural pieces, thus fabricating preliminary compacts, for example. Then, each preliminary compact is provided with a groove, and the grooves are attached together to form the exhaust holes.

As described above, according to the substrate heater of the present invention and the fabricating method thereof, the temperature uniformity of the substrate temperature is achieved by the simple steps of forming the heating surface into the convex shape. It is only necessary to add the simple steps to the conventional steps. Moreover, it is also possible to perform the correction operation after the inspection where appropriate. Accordingly, the present invention is extremely practical.

### EXAMPLES

The following describes examples 1 to 7 and comparative examples of the present invention.

Each of the substrate heaters according to the examples 1 to 7 is the substrate heater provided with the electrostatic chuck as shown in FIG. 2A. The substrate heaters are fabricated under the same conditions except that the conditions for processing the heating surface of the ceramics base into the convex shape are different from one another. The concrete conditions of fabrication will be described below. The conditions of fabrication refer to the flowchart shown in FIG. 3.

### Conditions of Fabrication

Firstly, the ceramics base was fabricated, with the electrostatic chuck electrode and the resistance-heating element embedded therein (S100). An acrylic resin binder was added to ceramics mixed powder which was prepared by adding 5% of Y₂O₃ to AIN powder obtained by a reduction-nitridation method, and granules were formed by a spray granulation method. The granules were put into a mold and pressed, thereby fabricating the preliminary compact. On the preliminary compact, a groove was formed in a position for embedding the resistance-heating element by use of a transfer mold. An Mo resistance-heating element having a wire shape and a diameter of 0.5 mm, which has been formed into a coil shape as shown in FIG. 3, was mounted in this groove. The ceramics raw material powder was put on the resistance-heating element, and these constituents were pressed. An electrostatic chuck electrode made of 24-mesh Mo wire mesh and having a diameter of 0.35 mm was mounted thereon, and then the ceramics raw material powder was further put thereon. Then, all the constituents were pressed together again in the uniaxial direction. The pressure was set to be 200 kg/cm² in each case. In this way, the compact of the ceramics base with the resistance-heating element and the electrostatic chuck electrode embedded therein was formed (S101).

The compact was taken out and sintered in a hot press sintering furnace. Conditions for sintering were set to a nitrogen atmosphere at gauge pressure of 0.5 kg/cm² and at temperature of 1860° C., which was maintained for 6 hours, whereby the sintered body was formed. The outside diameter of the sintered body was about 290 mm, and the thickness thereof was about 17 mm (S102). The position for embedding the resistance-heating element had depth of 8.5 mm from the upper surface of the heating surface, and the electrostatic chuck electrode was embedded at depth of 1.0 mm.

The lift pins and the purge gas holes were formed on this sintered body. The surface of the ceramics base to be the heating surface was subjected to a grinding operation with a rotary flat-surface grinding machine by use of a 200-mesh diamond abrasive paper and a grind stone. In this way, as shown in Table 1, the heating surface was formed into the convex shape in which the central portion is set to be highest and the heating surface was gradually lowered as it extends toward the peripheral portion. While the height of the central portion of the heating surface was expressed by Hc and the height of the edge portion of the heating surface was expressed by He, the differences ΔH (=Hc−He) in the height were set to 2 μm, 6 μm, 12 μm, 27 μm, 34 μm, 42 μm, and 52 μm respectively in the examples 1 to 7 (S103).

The shaft was fabricated by the following conditions. An acrylic resin binder was added to ceramics mixed powder which was prepared by adding 5% of Y₂O₃ to AIN powder obtained by a reduction-nitridation method, and granules were formed by a spray granulation method. By use of the granules, the compact was fabricated by applying the CIP method (S201).

The shaft compact was sintered by applying the normal pressure sintering method. Conditions for sintering were set to a nitrogen atmosphere and at temperature of 1850° C., which was maintained for 3 hours (S202). The diameter of an intermediate portion of the shaft obtained after sintering was about 40 mm, and the length of the shaft was about 200 mm. The thickness of the shaft at an intermediate portion of the tube was about 3 mm. The surfaces of the shaft and the joint surface to the ceramics base were subjected to a lapping operation (S203).

Yttrium nitrate aqueous solutions having an yttrium concentration of 2.6×10⁻⁶ mol/cc was coated on the respective joint surfaces to the ceramics base and to the shaft. The both joint surfaces were attached to each other, and were subjected to a heat treatment in a nitrogen atmosphere and at temperature of 1800° C. for 2 hours (S300).

After joint, the feed bar made of Ni was joined by brazing solder to the respective terminals for the resistance-heating element and for the electrostatic chuck electrode which were embedded in the ceramics base (S400).

### Evaluation

Each of the substrate heaters of the examples 1 to 7 and of the comparative examples was placed in a hermetically sealable chamber for evaluation, and a silicon substrate having a diameter of 300 mm was mounted on the heating surface. The inside of the chamber was set to a vacuum condition of 77 KPa, then the electricity was supplied to the electrostatic chuck electrode, and then the electricity is supplied to the resistance-heating element while fixing the substrate to the heating surface by adsorption. Temperature distribution on the substrate surface was measured under a condition of setting substrate temperature to 450° C. Results are shown in Table 1.

The temperature of the substrate surface was measured by use of a thermocouple. Each value in the row “temperature of outer peripheral portion of substrate” in Table 1 shows an average value of the temperature on the substrate surface measured at four points which divide a circumference having a radius of 140 mm into four equivalents. The temperature of the heating surface itself of the ceramics base was measured with a thermoviewer. In each case of the examples 1 to 7 and of the comparative examples, the surface temperature at the central portion of the heating surface was substantially equal to 449° C. and the surface temperature at the edge portion of the heating surface was substantially equal to 458° C., and the temperature at the central portion was lower by 9° C.

As shown in Table 1, it was confirmed that the distribution of the temperature on the substrate surface was changed by forming the heating surface into the convex shape and by varying the difference ΔH in the height between the central portion and the edge portion. In the range of the difference ΔH from 2 μm to about 50 μm, the temperature uniformity of the substrate tended to be more improved along with an increase in the difference ΔH. Particularly, in the example 6, the difference ΔH of 42 μm could substantially eliminate the difference in the temperature between the central portion and the outer peripheral portion of the substrate. The difference ΔH exceeding 50 μm does not exhibit sufficient adsorption by the electrostatic chuck at the outer peripheral portion of the substrate. Thereby the substrate was caused to float and stable retention was complicated. Therefore, the difference ΔH equal to or below 50 μm was preferred to obtain fine temperature uniformity and stable retention of the substrate. Under the setting condition of 450° C., the difference ΔH equal to or above 27 μm can suppress deviation in the temperature uniformity of the substrate temperature within 3° C. The difference ΔH equal to or above 34 μm can suppress deviation in the temperature uniformity of the substrate temperature within 1° C.

TABLE 1

| | EX- | EX- | EX- | EX- | EX- | EX- | EX- |
|---|---|---|---|---|---|---|---|
| | AM- | AM- | AM- | AM- | AM- | AM- | AM- |
| | PLE | PLE | PLE | PLE | PLE | PLE | PLE |
| EXAMPLE | 1 | 2 | 3 | 4 | 5 | 6 | 7 |
| HEATING | 2 | 6 | 12 | 27 | 34 | 42 | 52 |
| SURFACE | | | | | | | |
| FLATNESS OF | | | | | | | |
| CERAMICS | | | | | | | |
| SUBSTRATE | | | | | | | |
| ΔH = (Hc − He) (μm) | | | | | | | |
| SUBSTRATE | 447 | 447 | 447 | 448 | 448 | 449 | 449 |
| SURFACE | | | | | | | |
| TEMPERATURE | | | | | | | |
| (CENTRAL | | | | | | | |
| PORTION) | | | | | | | |
| Tc (° C.) | | | | | | | |
| SUBSTRATE | 454 | 453 | 451 | 451 | 449 | 449 | 448 |
| SURFACE | | | | | | | |
| TEMPERATURE | | | | | | | |
| (OUTER | | | | | | | |
| PERIPHERAL | | | | | | | |
| PORTION) | | | | | | | |
| Te (° C.) | | | | | | | |
| SUBSTRATE | −7 | −6 | −4 | −3 | −1 | 0 | 1 |
| TEMPERATURE | | | | | | | |
| UNIFORMITY | | | | | | | |
| Tc − Te (° C.) | | | | | | | |

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

1. A substrate heater comprising:
a plate-shaped ceramics base having a heating surface on a side of the ceramic base for placing a substrate thereon;
a resistance-heating element embedded in the ceramics base;
a tubular member joined to a central portion on another side of the ceramics substrate;
wherein the heating surface in a convex shape lowers in height as the heating surface extends from a central portion to a peripheral portion thereof.

2. A substrate heater of claim 1,
wherein the ceramics base comprises a planar electrode embedded therein between the heating surface and the resistance-heating element.

3. A substrate heater of claim 2,
wherein the planar electrode comprises a mesh-shaped electrode of a metal bulk body or a plate-shaped electrode with open holes.

4. A substrate heater of claim 1,
wherein the heating surface has a vacuum chuck hole configured to adsorb and fix the substrate on the heating surface.

5. A substrate heater of claim 1,
wherein the heating surface has a height Hc at the central portion and a height He at an end of the heating surface,
wherein the heights Hc, He have a difference ΔH of 50 μm or less therebetween.

6. A substrate heater of claim 1,
wherein the difference ΔH is set to 10 μm or more.

7. A substrate heater of claim 1,
wherein the ceramics substrate comprises a main component including a non-oxide ceramics or at least two non-oxide ceramics as a composite material selected from the group consisting of aluminum nitride, silicon nitride, silicon carbide and sialon.

8. A substrate heater of claim 1,
wherein the tubular member comprises a main component identical to that of the ceramics base.

9. A fabrication method for a substrate heater, comprising:
embedding a resistance-heating element in a plate-shaped ceramics base;
grinding a surface of the ceramics base into a convex heating surface, the heating surface lowering in height as the heating surface extends from a central portion to a peripheral portion thereof, and
joining a tubular member to a central portion on another surface of the ceramics substrate.

10. A fabrication method of claim 9,
wherein the step of embedding further comprises the step of embedding a planar electrode in the ceramics base.

11. A fabrication method of claim 9,
wherein the step of grinding further comprises the step of adjusting difference ΔH of 50 μm or less between height Hc of the central portion and height He of an end on the heating surface.

12. The fabrication method of claim 11,
wherein the difference ΔH is set to 10 μm or more.
